(19) United States
(12) Patent Application Publication
(10) Pub. No.: US 2014/0240472 A1
(43) Pub. Date: Aug. 28, 2014

(54) 3D SUBTITLE PROCESS DEVICE AND 3D SUBTITLE PROCESS METHOD

(71) Applicants: Koji Hamasaki, Hyogo (JP); Mitsuteru Kataoka, Osaka (JP)

(72) Inventors: Koji Hamasaki, Hyogo (JP); Mitsuteru Kataoka, Osaka (JP)

(73) Assignee: PANASONIC CORPORATION, Osaka (JP)

(21) Appl. No.: 14/349,292

(22) PCT Filed: Oct. 11, 2011
(86) PCT No.: PCT/JP2011/005678

§ 371 Date: Apr. 2, 2014

(51) Int. Cl. H04N 13/00

(52) U.S. Cl. CPC H04N 13/007
USPC 348/51

(57) ABSTRACT

A 3D subtitle process device causes a 3D display device to three-dimensionally display subtitles each indicated in corresponding subtitle data, including the following units. A setting control unit controls subtitle display setting regarding a subtitle display method performed by the 3D display device. A depth correction unit corrects at least one depth information included in corresponding subtitle data, so that a subtitle that starts display earlier among the subtitles is three-dimensionally displayed to appear deeper, when the subtitle display setting instructs a change of the subtitle display method and subtitles each indicated in corresponding subtitle data are to be displayed temporally overlapping on a screen. A subtitle drawing unit generates a 3D subtitle image from the pieces of the subtitle data in which at least one depth information has been corrected, so as to cause the 3D display device to three-dimensionally display the subtitles.

### TECHNICAL FIELD

The present invention relates to three-dimensional (3D) subtitle process devices and 3D subtitle process methods for displaying a plurality of 3D subtitles on a display unit.

### BACKGROUND ART

In recent years, television sets and personal computers capable of displaying 3D videos have been widely used. In order not to impair third dimension of videos displayed by such television sets and personal computers, fundamental technologies have been prepared for 3D display of text information (such as subtitles). For example, in Patent Literature 1 (PLT 1), in order not to cause a user as a viewer to feel a depth mismatch, a technique is disclosed to display subtitles ahead of each of objects in image. It is therefore possible to keep depth consistency between each object and a subtitle in image.

### CITATION LIST

### Patent Literature

### [PTL 1] Japanese Unexamined Patent Application Publication No. 2011-30200

### SUMMARY OF INVENTION

### Technical Problem

However, in the conventional technique, although the depth consistency between each object and a subtitle in image is kept, depth consistency between different subtitles is not considered. For example, if setting of a method for displaying subtitles in a 3D display device is changed (for example, a subtitle size is increased), a depth mismatch may occur between subtitles.

It is easy to imagine, for example, that the recent technology innovation will allow users to view 3D images not only by apparatuses having large screens, such as television sets, but also by mobile devices having small screens. In such a case, it is considered that, since it is difficult to see subtitles on a small screen, a subtitle size is changed in a display device. For example, if a subtitle size is increased, a plurality of subtitles sometimes overlap each other on a screen. Then, if such overlapping subtitles have the same depth, the subtitles make a user feel strangeness in viewing them because the depth is not different between the subtitles although the subtitles overlap each other on the display.

Thus, the present invention solves the above-described problem. It is an object of the present invention to provide a 3D subtitle process device and a 3D subtitle process method each of which is capable of decrease a depth mismatch in 3D display among a plurality of subtitles even if a method of displaying the subtitles is changed in a 3D display device.

### Solution to Problem

In accordance with an aspect of the present invention for achieving the object, there is provided a three-dimensional (3D) subtitle process device that causes a 3D display device to three-dimensionally display a plurality of subtitles indicated in pieces of subtitle data, the 3D subtitle process device including: a setting control unit configured to control subtitle display setting regarding a subtitle display method performed by the 3D display device; a depth correction unit configured to, when the subtitle display setting instructs a change of the subtitle display method and a plurality of subtitles each indicated in a corresponding one of pieces of subtitle data are to be displayed temporally overlapping on a screen, correct at least one of pieces of depth information each included in a corresponding one of the pieces of the subtitle data, so that a subtitle that starts display earlier among the subtitles is three-dimensionally displayed to appear deeper; and a subtitle drawing unit configured to generate a 3D subtitle image from the pieces of the subtitle data in which the at least one of the pieces of the depth information has been corrected, so as to cause the 3D display device to three-dimensionally display the subtitles.

With the above structure, it is possible to correct at least one of respective pieces of depth information of subtitles so that a subtitle that starts display earlier among subtitles to be displayed temporally overlapping on a screen is three-dimensionally displayed to appear deeper. As a result, when a new subtitle overlaps on an old subtitle on the screen, the new subtitle is three-dimensionally displayed to appear ahead of the old subtitle. In other words, it is possible to keep a consistency between a way of overlapping the subtitles on the screen and depths of the subtitles. As a result, a depth mismatch in 3D display between the subtitles can be decreased. In addition, when a plurality of subtitles are dispersed on the screen, it is possible to make easy to find the latest subtitle from the subtitles.

It is also possible that the 3D subtitle process device further includes a subtitle region calculation unit configured to calculate, based on the pieces of the subtitle data and the subtitle display setting, display regions of the subtitles on the screen, wherein the depth correction unit is configured to correct the at least one of the pieces of the depth information when at least parts of the display regions which are calculated overlap each other on the screen.

With the above structure, it is possible to correct depth information only when a plurality of subtitles overlap each other on the screen. In other words, it is possible to efficiently correct depth information only when there is a high possibility that a mismatch occurs between a way of overlapping subtitles on the screen and depths of the subtitles. In addition, it is possible to prevent that the correction of the depth information deteriorates a depth indicated in original subtitle data.

It is still possible that the depth correction unit is configured (i) to correct the at least one of the pieces of the depth information when the subtitles have different types, and (ii) not to correct the pieces of the depth information when the subtitles have a same type.

With the above structure, it is possible to prevent correction of depth information when a plurality of subtitles have the same type. As a result, for example, it is possible to prevent that a plurality of subtitles corresponding to a series of speeches of the same person are three-dimensionally displayed with different depths. Therefore, it is possible to decrease user's discomfort caused by correction of depth information.

It is still further possible that the depth correction unit is configured (i) to correct the at least one of the pieces of the depth information when a difference of a display start time between the subtitles is greater than or equal to a threshold value, and (ii) not to correct the pieces of the depth information when the difference is smaller than the threshold value.

With the above structure, it is possible to set the same depth for a plurality of subtitles when displaying of the subtitles starts sequentially one by one. As a result, for example, it is possible to prevent that a plurality of subtitles corresponding to a series of speeches of the same person are three-dimensionally displayed with different depths. Therefore, it is possible to decrease user's discomfort caused by correction of depth information.

It is still further possible that the setting control unit is configured to control, as the subtitle display setting, setting regarding at least one of a subtitle display size and a subtitle display duration in the 3D display device.

With the above structure, it is possible to correct depth information when setting regarding at least one of a subtitle display size and a subtitle display duration is changed. In other words, it is possible to correct depth information when a change of setting which has a high possibility of displaying a plurality of subtitles to overlap each other is performed.

It is still further possible that the 3D subtitle process device further includes: a video output unit configured to output, to the 3D display device, a 3D subtitle video in which the 3D subtitle image is superimposed on a 3D video; and an operation receiving unit configured to receive an operation of a user for at least one of the subtitles three-dimensionally displayed on the 3D display device, wherein the video output unit is configured to output the 3D subtitle video in a special reproduction mode, when the operation received is a predetermined operation.

With the above structure, it is possible to output a 3D subtitle video in a special reproduction mode corresponding to a user's operation for a three-dimensionally displayed subtitle. In other words, the user can control the special reproduction mode by an intuitive operation on a subtitle.

It is still further possible that, when the operation received is an operation for moving at least one of the subtitles that are three-dimensionally displayed to appear near to the user, the video output unit is configured to output the 3D subtitle video in a rewind reproduction mode.

With the above structure, it is possible to perform rewind reproduction by performing an operation for moving a three-dimensionally displayed subtitle to be near to the user. In other words, since rewind reproduction can be performed by an operation for approaching an old subtitle to a new subtitle, the user can control a special reproduction mode by an intuitive operation on a subtitle.

It is still further possible that, when the operation received is an operation for moving at least one of the subtitles that are three-dimensionally displayed to appear at depth, the video output unit is configured to output the 3D subtitle video in a fast-forward reproduction mode.

With the above structure, it is possible to perform fast-forward reproduction by performing an operation for moving a three-dimensionally displayed subtitle to appear at depth. In other words, since fast-forward reproduction can be performed by an operation for approaching a new subtitle to an old subtitle, the user can control a special reproduction mode by an intuitive operation on a subtitle.

It is still further possible that, when an operation for moving at least one of the subtitles that are three-dimensionally displayed to appear at depth is received, the setting control unit is configured to change the subtitle display setting so that a display duration of each of the subtitles for a video on the 3D display device is longer than a display duration of a subtitle for the video which is indicated in a corresponding one of the pieces of the subtitle data.

With the above structure, it is possible to prevent that a display duration of a subtitle is too short in a fast-forward reproduction mode.

It should be noted that the present invention may be implemented not only to the 3D subtitle process device described above, but also to a 3D subtitle process method including steps performed by the characteristic structural elements included in the 3D subtitle process device.

### Advantageous Effects of Invention

The present invention can decrease a depth mismatch in 3D display among a plurality of subtitles, even if a method of displaying subtitles is changed in a 3D display device.

### BRIEF DESCRIPTION OF DRAWINGS

FIG. 1 is an external view of a 3D display system including a 3D subtitle process device according to Embodiment 1 of the present invention.

FIG. 2 is a block diagram of a functional structure of the 3D subtitle process device according to Embodiment 1 of the present invention.

FIG. 3 is a flowchart of processing performed by the 3D subtitle process device according to Embodiment 1 of the present invention.

FIG. 4 is a diagram for explaining a plurality of subtitles three-dimensionally displayed according to Embodiment 1 of the present invention.

FIG. 5 is a block diagram of a functional structure of the 3D subtitle process device according to Embodiment 2 of the present invention.

FIG. 6 is a block diagram of a detailed functional structure of a 3D subtitle process unit according to Embodiment 2 of the present invention.

FIG. 7 is a diagram for explaining an example of processing performed by a subtitle region calculation unit according to Embodiment 2 of the present invention.

FIG. 8 is a diagram for explaining an example of a plurality of display regions calculated by a subtitle region calculation unit according to Embodiment 2 of the present invention.

FIG. 9 is a diagram for explaining another example of a plurality of display regions calculated by the subtitle region calculation unit according to Embodiment 2 of the present invention.

FIG. 10 is a diagram illustrating an example of a disparity corrected by a depth correction unit according to Embodiment 2 of the present invention.

FIG. 11 is a graph plotting an example of a correction method performed by the depth correction unit for correcting depth information according to Embodiment 2 of the present invention.

FIG. 12 is a flowchart of processing performed by the 3D subtitle process device according to Embodiment 2 of the present invention.

FIG. 13 is a diagram for explaining a calculation method performed by the depth correction unit for calculating the depth information according to Embodiment 2 of the present invention.

FIG. 14 is a diagram for explaining an example of processing performed by a depth correction unit according to Embodiment 3 of the present invention.

FIG. 15 is a diagram for explaining an example of processing performed by a depth correction unit according to Embodiment 3 of the present invention.

FIG. 16 is a flowchart of processing performed by a 3D subtitle process device according to Embodiment 3 of the present invention.

FIG. 17 is a block diagram of a functional structure of a 3D subtitle process device according to Embodiment 4 of the present invention.

FIG. 18 is a flowchart of processing performed by a 3D subtitle process device according to Embodiment 4 of the present invention.

FIG. 19 is a diagram for explaining an example of processing performed by a 3D subtitle process device according to Embodiment 4 of the present invention.

### DESCRIPTION OF EMBODIMENTS

Hereinafter, certain exemplary embodiments are described in greater detail with reference to the accompanying Drawings. It should be noted that all the embodiments described below are specific examples of the present invention. Numerical values, shapes, materials, constituent elements, arrangement positions and the connection configuration of the constituent elements, steps, the order of the steps, and the like described in the following embodiments are merely examples, and are not intended to limit the present invention. The present invention is characterized by the appended claims. Therefore, among the constituent elements in the following embodiments, constituent elements that are not described in independent claims that illustrate the most generic concept of the present invention are described as elements constituting more desirable configurations, although such constituent elements are not necessarily required to achieve the object of the present invention.

### Embodiment 1

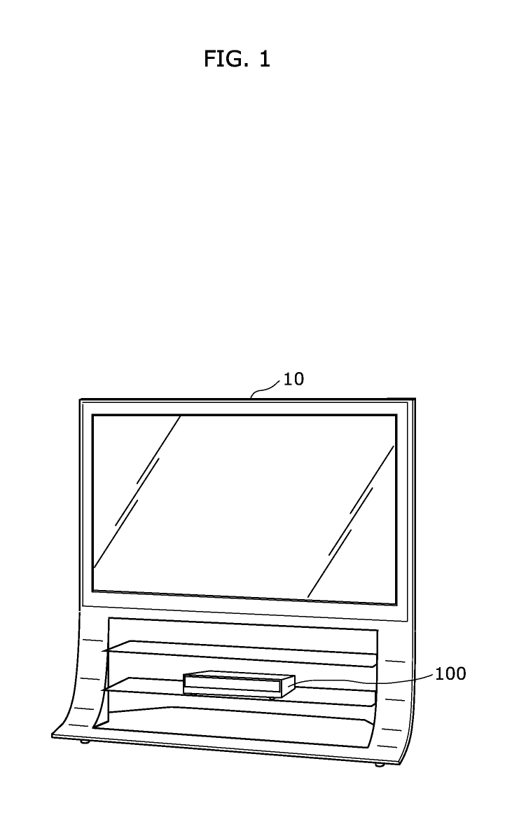

FIG. 1 is an external view of a 3D display system including a 3D subtitle process device 100 according to Embodiment 1 of the present invention. As illustrated in FIG. 1, the 3D display system includes a 3D display device 10 and a 3D subtitle process device 100 connected to the 3D display device 10.

The 3D display device 10 three-dimensionally displays subtitles, by displaying, on a screen, 3D subtitle images received from the 3D subtitle process device 100. For example, the 3D display device 10 three-dimensionally displays subtitles by a 3D display system with glasses. The 3D display system with glasses is a system by displaying a right-eye image and a left-eye image having a disparity, for a user wearing glasses (for example, liquid crystal shutter glasses or polarization glasses). For another example, the 3D display device 10 may three-dimensionally display subtitles by autostereoscopy. The autostereoscopy is a 3D display system without using glasses (for example, a parallax barrier method or a lenticular lens method).

It should be noted that the 3D display device 10 is not necessarily a stationary apparatus as illustrated in FIG. 1. For example, the 3D display device 10 may be a mobile device (for example, a mobile telephone, a tablet PC, or a portable game machine).

The 3D subtitle process device 100 generates a 3D subtitle image to cause the 3D display device 10 to three-dimensionally display a plurality of subtitles indicated in respective pieces of subtitle data. Each of the pieces of subtitle data includes depth information indicating a display position (for example, a disparity) in a depth direction of the subtitle.

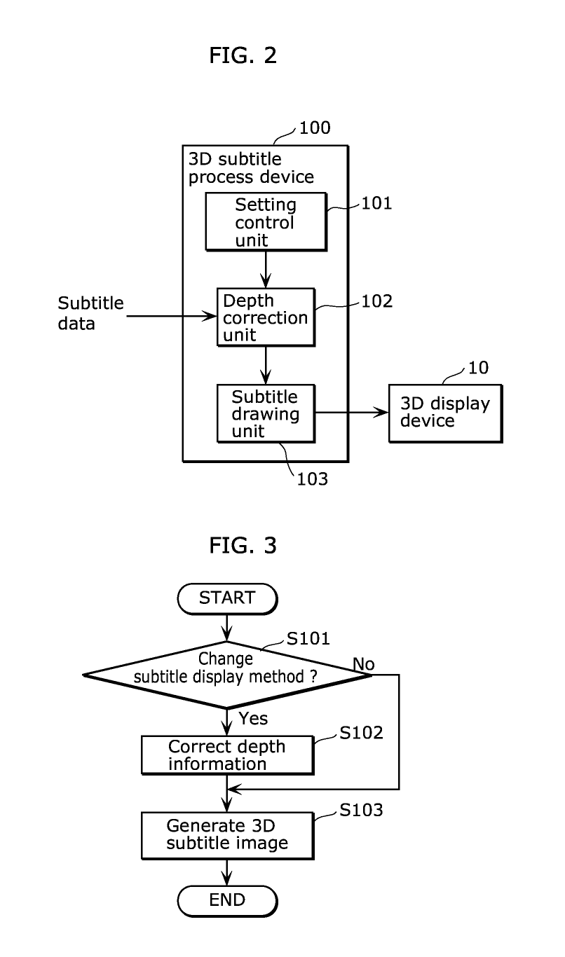

FIG. 2 is a block diagram of a functional structure of the 3D subtitle process device 100 according to Embodiment 1 of the present invention. As illustrated in FIG. 2, the 3D subtitle process device 100 includes a setting control unit 101, a depth correction unit 102, and a subtitle drawing unit 103. The following describes these structural elements in more detail.

The setting control unit 101 controls subtitle display setting regarding a method of displaying subtitles (subtitle display method) in the 3D display device 10. For example, the setting control unit 101 changes the subtitle display setting according to instructions (user instruction) from a user to change the subtitle display method. It should be noted that the subtitle display setting is valid for the 3D display device 10.

More specifically, the setting control unit 101 controls, for example, as the subtitle display setting, setting regarding at least one of a subtitle display size and a subtitle display duration in the 3D display device 10. Therefore, the setting control unit 101 can control, as the subtitle display setting, setting regarding a subtitle display method which greatly influences whether or not a plurality of subtitles are displayed overlapping.

It should be noted that the setting control unit 101 may control, as the subtitle display setting, setting regarding a subtitle display method rather than setting regarding a subtitle display size and a subtitle display duration. For example, the setting control unit 101 may control, as the subtitle display setting, setting regarding a display position or a font of a subtitle on a screen.

The depth correction unit 102 receives plural pieces of subtitle data. More specifically, the depth correction unit 102 receives pieces of subtitle data via, for example, broadcasting or a communication network.

Furthermore, if the subtitle display setting indicates that the subtitle display method is to be changed (instructs a change of the subtitle display method) and a plurality of subtitles are to be displayed temporally overlapping on the screen, the depth correction unit 102 corrects at least one of pieces of depth information included in pieces of subtitle data. Here, among the plurality of subtitles to be displayed temporally overlapping which are indicated by the pieces of subtitle data, the depth correction unit 102 corrects at least one of the pieces of depth information so that a subtitle that starts display earlier is three-dimensionally displayed to appear deeper. In other words, the depth correction unit 102 corrects at least one of the pieces of depth information so that, among the plurality of subtitles indicated in the pieces of subtitle data, a subtitle that starts display later is three-dimensionally displayed to appear nearer to a user(viewer).

This means that the depth correction unit 102 corrects at least one of pieces of depth information so that, among a plurality of subtitles displayed temporally overlapping on the screen, a subtitle (old subtitle) displayed at an earlier display start time is three-dimensionally displayed to appear deeper than a subtitle (new subtitle) displayed at a later display start time. In other words, the depth correction unit 102 corrects at least one of pieces of depth information so that, among a plurality of subtitles displayed temporally overlapping on the screen, a new subtitle is three-dimensionally displayed ahead of an old subtitle.

More specifically, for example, if the depth information indicates a disparity and subtitles are three-dimensionally displayed ahead of the screen, the depth correction unit 102 corrects at least one of pieces of depth information so that a subtitle that starts display earlier among the subtitles has a smaller disparity.

It should be noted that the depth correction unit 102 may correct all of the pieces of depth information, or correct only one of the pieces of depth information.

The subtitle drawing unit 103 generates a 3D subtitle image from pieces of subtitle data in which at least one of pieces of depth information has been corrected, so as to cause the 3D display device 10 to three-dimensionally display a plurality of subtitles. More specifically, the subtitle drawing unit 103 generates, a 3D subtitle image, a right-eye image including a plurality of subtitles and a left-eye image including the plurality of subtitles having a disparity for the right-eye image.

Next, each step of the processing performed by the 3D subtitle process device 100 having the above-described structure is described. FIG. 3 is a flowchart of processing performed by the 3D subtitle process device 100 according to Embodiment 1 of the present invention.

First, the depth correction unit 102 determines whether or not the subtitle display setting indicates that a subtitle display method is to be changed (S101). In other words, it is determined whether or not the subtitle display setting controlled by the setting control unit 101 indicates that a subtitle display method for a subtitle indicated in the subtitle data is to be changed.

Here, if the subtitle display setting indicates that the subtitle display method is to be changed (Yes at S101), then the depth correction unit 102 corrects at least one of the pieces of depth information included in the pieces of subtitle data (S102). More specifically, the depth correction unit 102 corrects at least one of the pieces of depth information so that a subtitle that starts display earlier among the subtitles to be displayed temporally overlapping on the screen is displayed to appear deeper. On the other hand, if the subtitle display setting indicates that the subtitle display method is not to be changed (No at S101), then the depth correction unit 102 does not correct any piece of depth information.

Subsequently, the subtitle drawing unit 103 generates, by using the pieces of subtitle data, a 3D subtitle image for three-dimensionally displaying the plurality of subtitles on the 3D display device 10 (S103). It means that, when the subtitle display setting indicates that the subtitle display method is to be changed, the subtitle drawing unit 103 generates a 3D subtitle image from the pieces of subtitle data in which at least one of the pieces of depth information has been corrected. On the other hand, if the subtitle display setting is not changed, the subtitle drawing unit 103 generates a 3D subtitle image directly from the pieces of subtitle data in which any piece of the depth information is not corrected.

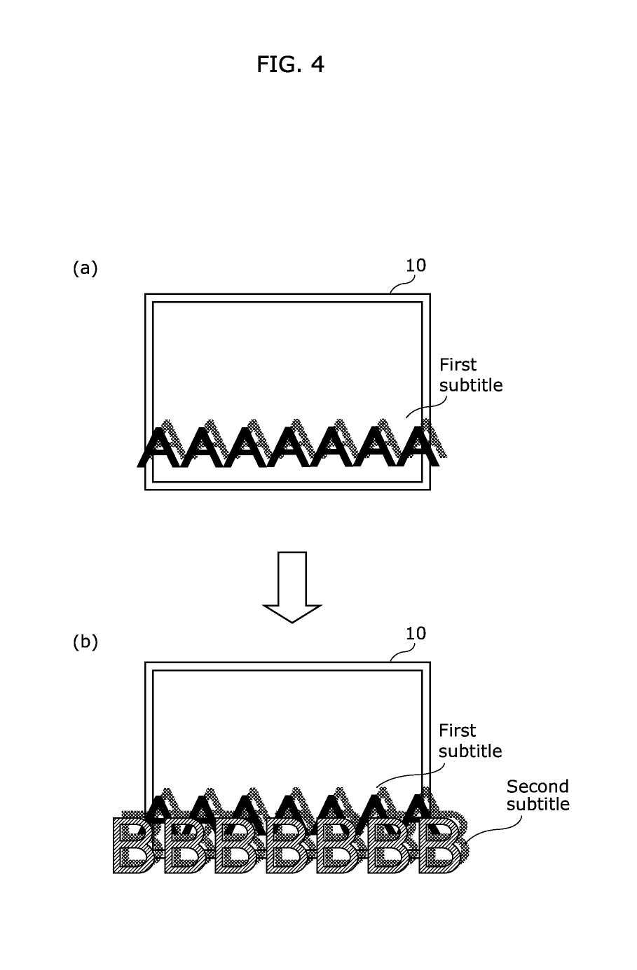

FIG. 4 is a diagram for explaining a plurality of subtitles three-dimensionally displayed according to Embodiment 1 of the present invention. In FIG. 4, the subtitle display setting indicates that the subtitle display method is to be changed in the 3D display device 10.

First, the 3D subtitle process device 100 receives first subtitle data indicating a first subtitle “AAAAAAA”. In this case, since a plurality of subtitle are not displayed temporally overlapping on the screen, the depth correction unit 102 does not correct depth information included in the first subtitle data. Therefore, as illustrated in (a) in FIG. 4, the first subtitle is three-dimensionally displayed according to the depth information included in the first subtitle.

After that, the 3D subtitle process device 100 receives second subtitle data indicating a second subtitle “BBBBBBB”. Here, the depth correction unit 102 corrects depth information included in the first subtitle data or the second subtitle data, so that the first subtitle that has started display earlier than the second subtitle is three-dimensionally displayed to appear deeper than the second subtitle. As a result, as illustrated in (b) in FIG. 4, the first subtitle that is an old subtitle is three-dimensionally displayed to appear deeper than the second subtitle that is a new subtitle. In other words, the second subtitle is three-dimensionally displayed ahead of the first subtitle.

As described above, the 3D subtitle process device 100 according to the present embodiment is capable of correcting pieces of depth information of a plurality of subtitles so that, among the subtitles displayed temporally overlapping on the screen, a subtitle that starts display earlier is three-dimensionally displayed to appear deeper. As a result, when a new subtitle is displayed on an old subtitle on the screen, the new subtitle is three-dimensionally displayed ahead of the old subtitle. In other words, it is thereby possible to keep consistency between a way of overlapping subtitles on a screen and depths of the subtitles. As a result, a depth mismatch among a plurality of subtitles can be decreased. In addition, if a plurality of subtitles are dispersed on a screen, it is possible to make easy to find the latest subtitle from the subtitles.

### Embodiment 2

Next, Embodiment 2 according to the present embodiment is described. The 3D subtitle process device 200 according to the present embodiment switches whether or not to correct depth information, according to whether or not at least parts of display regions of subtitles overlap one another on the screen. It should be noted that the following description is given for the situation where subtitles are three-dimensionally displayed to appear popping out from the screen and the depth information indicates a disparity.

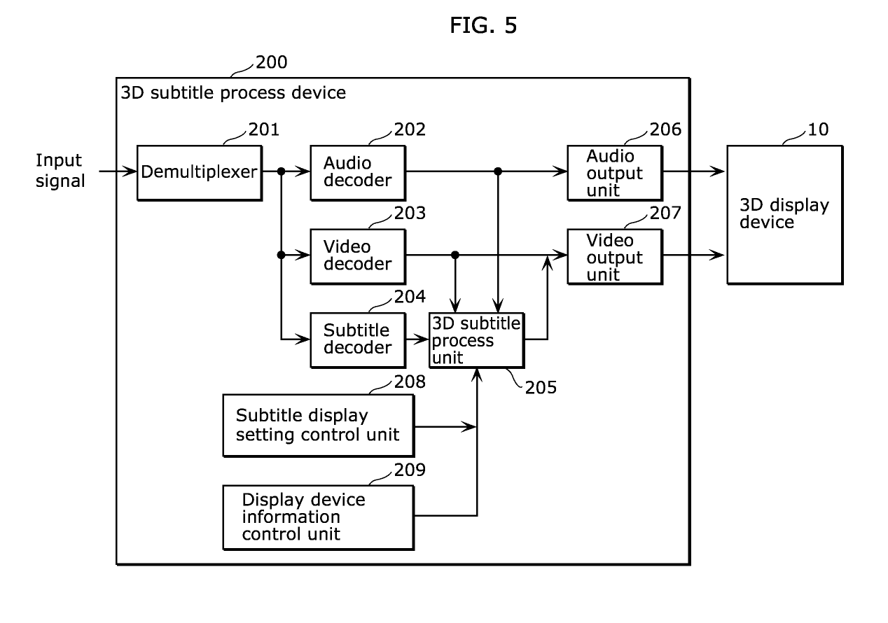

FIG. 5 is a block diagram of a functional structure of a 3D subtitle process device 200 according to Embodiment 2 of the present invention. As illustrated in FIG. 5, the 3D subtitle process device 200 according to the present embodiment includes a demultiplexer 201, an audio decoder 202, a video decoder 203, a subtitle decoder 204, a 3D subtitle process unit 205, an audio output unit 206, a video output unit 207, a subtitle display setting control unit 208, and a display device information control unit 209.

The demultiplexer 201 extracts packets (PES packets) of video, audio, and subtitles from input signals, and transmits the extracted packets to the respective decoders.

The audio decoder 202 reconstructs an audio elementary stream from the audio packets extracted from the demultiplexer 201. Then, the audio decoder 202 obtains audio data by decoding the audio elementary stream.

The video decoder 203 reconstructs a video elementary stream from the video packets extracted by the demultiplexer 201. Then, the video decoder 203 obtains video data by decoding the video elementary stream.

The subtitle decoder 204 reconstructs a subtitle elementary stream from the subtitle packets extracted from the demultiplexer 201. Then, the subtitle decoder 204 obtains pieces of subtitle data by decoding the subtitle elementary stream. Each of the pieces of subtitle data includes text information indicating details of the subtitle, position information indicating a display position of the subtitle, depth information indicating a disparity of the subtitle, and the like. Hereinafter, subtitle data obtained by the subtitle decoder 204 is referred to also as input subtitle data.

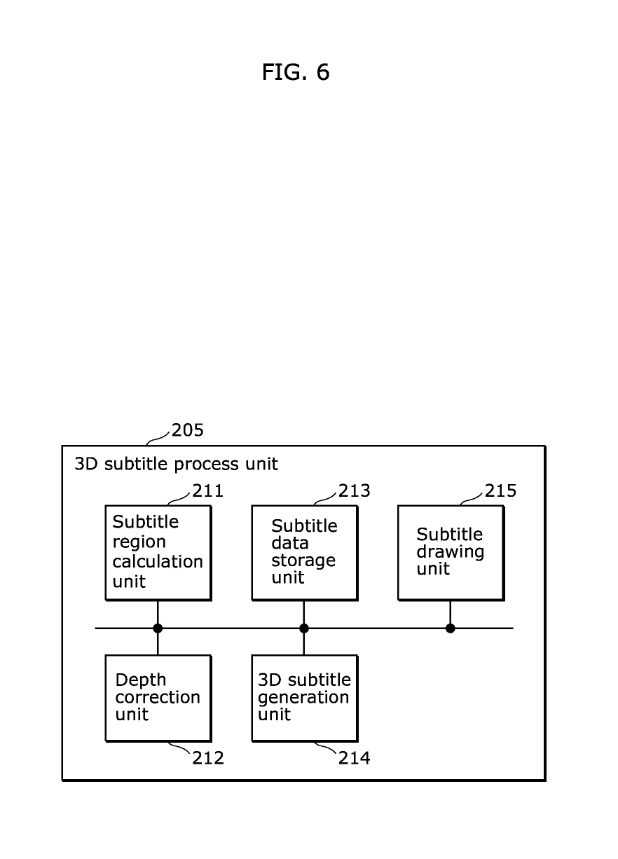

The 3D subtitle process unit 205 generates a 3D subtitle image from (a) one or more pieces of input subtitle data obtained by the subtitle decoder 204, the video data (for example, disparity vectors) obtained by the video decoder 203, and the audio data obtained by the audio decoder 202. The 3D subtitle process unit 205 will be described in more detail with reference to FIG. 6.

The audio output unit 206 provides the 3D display device 10 with the audio data obtained by the audio decoder 202.

The video output unit 207 generates a 3D subtitle video by superimposing a 3D subtitle image generated by the 3D subtitle process unit 205 on a 3D video indicated in the video data obtained by the video decoder 203. Then, the video output unit 207 provides the generated 3D subtitle video to the 3D display device 10.

The subtitle display setting control unit 208 corresponds to the setting control unit 101 in Embodiment 1. The subtitle display setting control unit 208 controls the subtitle display setting (for example, a subtitle display size or a subtitle display duration) according to instructions from the user. The subtitle display setting control unit 208 stores information indicating current subtitle display setting in a rewritable nonvolatile storage device (for example, a hard disk or a flash memory).

The display device information control unit 209 controls information regarding the 3D display device 10 connected to the 3D subtitle process device 200 (for example, a screen resolution, a screen size, or the like).

Subsequently, the 3D subtitle process unit 205 is described in more detail. FIG. 6 is a block diagram of a detailed functional structure of a 3D subtitle process unit 205 according to Embodiment 2 of the present invention.

As illustrated in FIG. 6, the 3D subtitle process unit 205 includes a subtitle region calculation unit 211, a depth correction unit 212, a subtitle data storage unit 213, a 3D subtitle generation unit 214, and a subtitle drawing unit 215. The following describes each of the structural elements included in the 3D subtitle process unit 205.

The subtitle region calculation unit 211 calculates a display region of a subtitle on the screen based on (a) the input subtitle data obtained by the subtitle decoder 204 (for example, a subtitle display size and a subtitle display position), (b) the subtitle display setting obtained by the subtitle display setting control unit 208, and (c) a size and a resolution of the screen of the 3D display device 10 which are obtained from the display device information control unit 209.

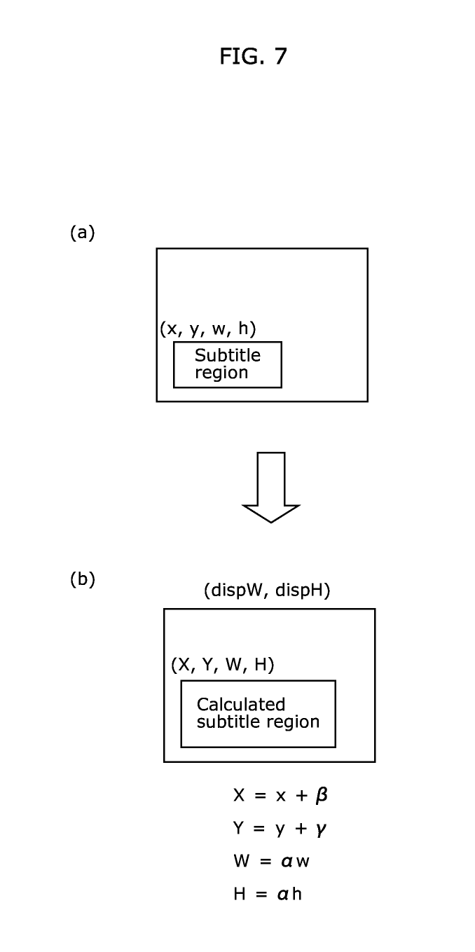

Here, the processing performed by the subtitle region calculation unit 211 is described with reference to FIG. 7. FIG. 7 is a diagram for explaining an example of the processing performed by the subtitle region calculation unit 211 according to Embodiment 2 of the present invention.

For example, as illustrated in (a) in FIG. 7, it is assumed that the input subtitle data indicates a subtitle display position (x, y) on the screen and a width and a height (w, h) of the subtitle display region for each subtitle. Here, if the subtitle display setting obtained from the subtitle display setting control unit 208 indicates an enlargement factor α, the subtitle region calculation unit 211 calculates, as illustrated in (b) in FIG. 7, a value generated by multiplying, by the enlargement factor α, the width and the height (w, h) of the subtitle display region indicated in the input subtitle data, as a width and a height (W, H) of a resulting calculated subtitle display region. Furthermore, the subtitle region calculation unit 211 calculates a value generated by adding each of a correction value β and a correction value γ to the subtitle display position (x, y) indicated in the input subtitle data, as a resulting calculated subtitle display position (X, Y).

The correction values β and γ are calculated to cause the calculated subtitle display region not to be out of the screen. For example, if a sum of the height (H) of the calculated subtitle display region and the subtitle display position (γ) in a vertical direction which is indicated in the input subtitle data exceeds a screen size dispH obtained from the display device information control unit 209, the correction value γ is calculated as γ=(γ+H)−dispH.

It should be noted that the method of calculating subtitle display regions is not limited to the above. For example, the subtitle region calculation unit 211 may calculate a subtitle display region so that a resulting calculated subtitle display position is not displaced from a subtitle display position of a subtitle that starts display temporally before or after a target subtitle (hereinafter, referred to as an “anteroposterior subtitle”). Furthermore, if the entire subtitle display region is not within the screen when the subtitle display region is increased at a enlargement factor instructed from the user, the subtitle region calculation unit 211 may automatically change the enlargement factor. Moreover, the subtitle display region may be out of the screen. The subtitle display setting instructed from the user may indicate not only the above-described enlargement factor but also an absolute value of a display size.

The depth correction unit 212 re-calculates a disparity indicating a depth of a subtitle. More specifically, like the depth correction unit 102 according to Embodiment 1, if the subtitle display setting indicates that the subtitle display method is to be changed when a plurality of subtitles are to be displayed temporally overlapping on the screen, the depth correction unit 212 corrects at least one of pieces of depth information included in pieces of subtitle data. Here, the depth correction unit 212 corrects at least one of the pieces of depth information so that a subtitle that starts display earlier among the plurality of subtitles indicated by the pieces of subtitle data is three-dimensionally displayed to appear deeper.

However, the depth correction unit 212 according to the present embodiment corrects at least one of the pieces of depth information, when at least parts of display regions calculated by the subtitle region calculation unit 211 overlap each other on the screen. In other words, according to the present embodiment, the depth correction unit 212 determines whether or not at least parts of display regions overlap each other on the screen. Then, only when at least parts of display regions overlap each other on the screen, the depth correction unit 212 corrects at least one of pieces of depth information. In other words, if a plurality of display regions do not overlap each other on the screen, the depth correction unit 212 does not correct any piece of depth information.

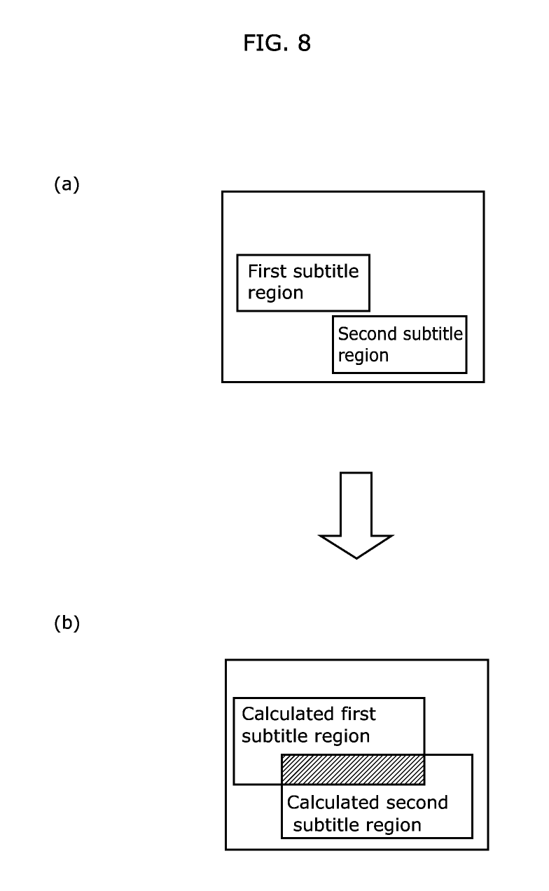

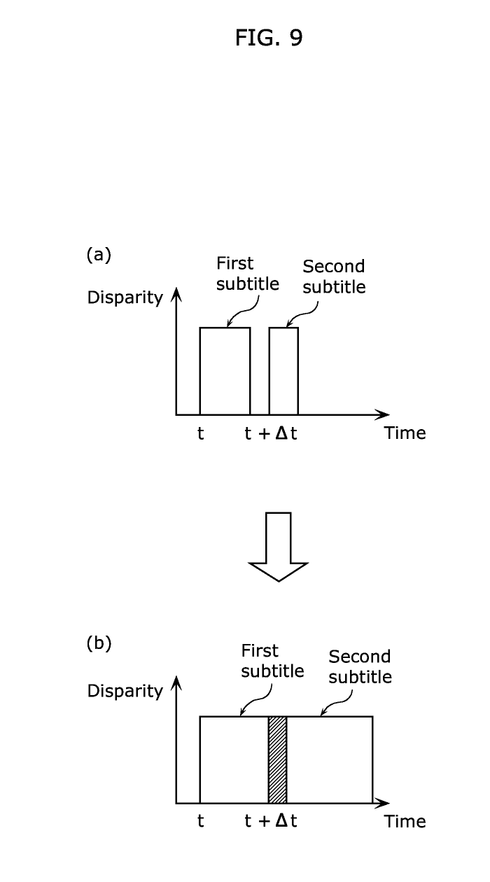

Here, the processing performed by the depth correction unit 212 is described in more detail with reference to the drawings. Each of FIGS. 8 and 9 is a diagram for explaining an example of a plurality of display regions calculated by the subtitle region calculation unit 211 according to Embodiment 2 of the present invention.

For example, it is assumed that pieces of input subtitle data indicate the first subtitle region illustrated in (a) in FIG. 8 as a display region of the first subtitle, and the second subtitle region illustrated in (a) in FIG. 8 as a display region of the second subtitle. Here, if the subtitle region calculation unit 211 calculates these display regions based on the subtitle display setting indicating that the display regions of the subtitles are to be enlarged, the calculated first and second subtitle regions may overlap each other on the screen as illustrated in (b) in FIG. 8. When a plurality of display regions overlap each other on the screen as described above and disparities of the subtitles are the same, the user feels a depth mismatch. For example, when the second subtitle overlap on the first subtitle on the screen, the user feels a depth mismatch if the first subtitle is three-dimensionally displayed ahead of the second subtitle or at the same depth position as that of the second subtitle.

Furthermore, as illustrated in FIG. 9, when the user instructs a change of a subtitle display duration in the 3D display device 10, subtitle display regions may overlap each other. For example, if subtitles are displayed according to pieces of subtitle data added to broadcast data, subtitle display regions do not overlap because a plurality of subtitles are not displayed at the same time. However, if the subtitle display duration is changed according to a change of the subtitle display setting, a plurality of subtitle display regions may overlap each other on the screen.

More specifically, as illustrated in (a) in FIG. 9, for example, there is a situation where the second subtitle is displayed at time t+Δt after the first subtitle is displayed at time t. In FIG. 9, the first subtitle and the second subtitle have the same disparity (depth information). Therefore, if a subtitle display duration is extended as illustrated in (b) in FIG. 9, in a time period (hatched region) during which both the first subtitle and the second subtitle are displayed, the user feels a depth mismatch due to the same disparity between the first and second subtitles although the second subtitle region overlaps on the first subtitle region.

In order to prevent the depth mismatch as illustrated in FIGS. 8 and 9, the depth correction unit 212 corrects a disparity indicated in input subtitle data, based on a subtitle display start time of a subtitle displayed (or to be displayed) on the screen which is obtained by the subtitle data storage unit 213 described below. According to the present embodiment, a disparity is corrected to display the latest subtitle to appear the nearest to the user among a plurality of subtitles.

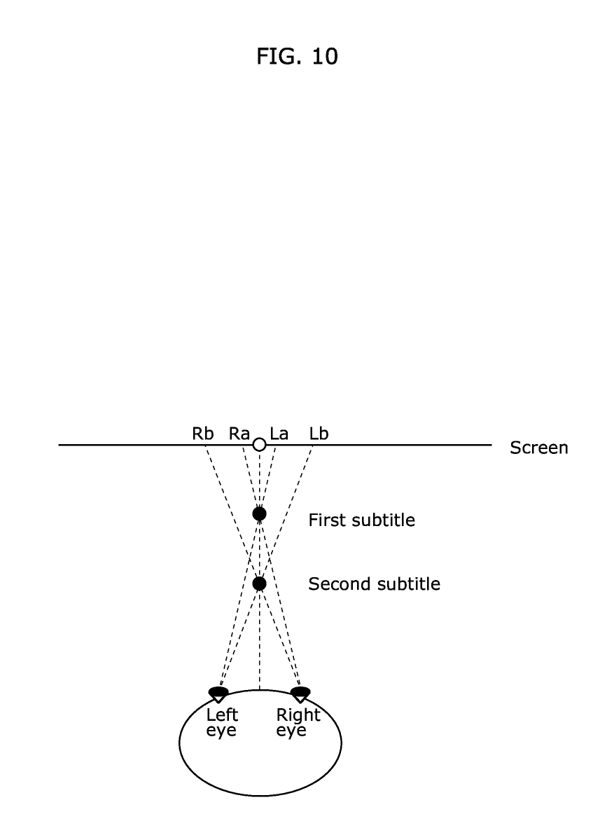

FIG. 10 is a diagram illustrating an example of disparities corrected by the depth correction unit 212 according to Embodiment 2 of the present invention. More specifically, FIG. 10 illustrates corrected disparities of the first and second subtitles at time t+Δt in FIG. 9.

In FIG. 10, each of disparities of the first and second subtitles indicated in the respective pieces of input subtitle data is assumed to be (Ra, La). In this case, if the disparities indicated in the pieces of input subtitle data are not corrected, the first and second subtitles are three-dimensionally displayed at the same disparity. This means that a depth of the first subtitle is the same as the depth of the second subtitle. However, since the second subtitle overlaps on the first subtitle on the screen, there is a mismatch between a way of overlapping subtitles and depths of the subtitles. Therefore, the depth correction unit 212 corrects the disparities to display the latest subtitle to appear ahead of the any other subtitle.

In FIG. 10, the depth correction unit 212 corrects the disparity of the second subtitle that is the latest subtitle to (Rb, Lb). As a result, the second subtitle is three-dimensionally displayed ahead of the first subtitle. (Rb, Lb) is calculated by adding, for example, a desired offset amount (for example, a predetermined fixed value) to (Ra, La).

It is also possible to calculate (Rb, Lb) by adding, for example, a value dynamically calculated using a disparity of video to (Ra, La). For example, it is also possible that, if video included in a region displayed with the first subtitle has a larger disparity, the offset amount is larger.

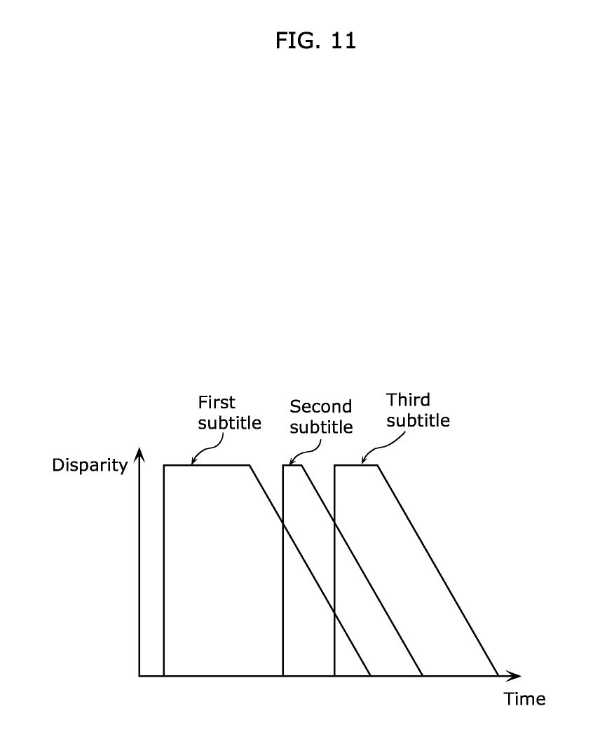

FIG. 11 is a graph plotting an example of a correction method performed by the depth correction unit 212 for correcting depth information according to Embodiment 2 of the present invention. In FIG. 11, a disparity of each subtitle is corrected to be smaller, as time has passed since a time when display of a target subtitle starts (hereinafter, referred to as a “display start time” or “display start timing”). In other words, the depth correction unit 212 corrects depth information of each subtitle data so that a display position of a subtitle shifts deeper as time passes. As a result, in FIG. 11, among a plurality of subtitles, a subtitle that starts display earlier is three-dimensionally displayed to appear deeper.

The subtitle data storage unit 213 holds subtitle data (a subtitle display region, a disparity, a subtitle display duration, and the like) updated according to information calculated by the subtitle region calculation unit 211 and the depth correction unit 212.

As described with reference to FIG. 10, according to the present embodiment, the depth information is corrected to display the latest subtitle to appear the nearest to the user. Every time a subtitle is updated, the depth correction unit 212 provides a large disparity to a newly displayed subtitle, while decreasing a disparity (depth) indicated in each subtitle data held in the subtitle data storage unit 213. Therefore, the subtitle data storage unit 213 holds a time (display start time) of starting subtitle display for each subtitle currently displayed on the screen.

The depth correction unit 212 re-calculates a disparity of each displaying subtitle based on the corresponding display start time, when a new subtitle is updated. It should be noted that the subtitle data storage unit 213 may hold only subtitle data of subtitles currently displayed on the screen, or hold also subtitle data of subtitles not displayed on the screen any longer.

The 3D subtitle generation unit 214 generates a 3D subtitle to be displayed on the screen, from subtitle data held in the subtitle data storage unit 213. More specifically, the 3D subtitle generation unit 214 acquires, when a new subtitle is updated, pieces of subtitle data sequentially in order of older display start times among subtitles currently displayed on the screen, and provides the acquired pieces of subtitle data to the subtitle drawing unit 215.

The subtitle drawing unit 215 corresponds to the subtitle drawing unit 103 in Embodiment 1. The subtitle drawing unit 215 generates a 3D subtitle image by sequentially drawing the pieces of subtitle data provided from the 3D subtitle generation unit 214. The drawing may be performed on a memory for On-Screen Display (OSD). After drawing all of the pieces of subtitle data provided from the 3D subtitle generation unit 214, the subtitle drawing unit 215 provides a right of accessing the memory region in which the subtitles are drawn (for example, an OSD drawing memory) to the video output unit 207. The video output unit 207 synthesizes the 3D video indicated by the video data obtained by the video decoder 203 and the 3D subtitle image obtained from the subtitle drawing unit 215, and provides the resulting 3D subtitle video to the 3D display device 10.

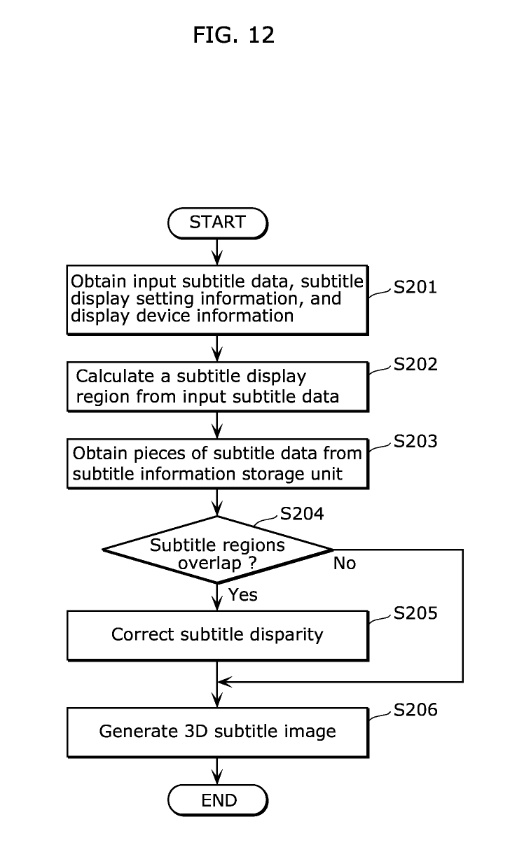

Subsequently, the flow of the processing performed by the 3D subtitle process device 200 having the above-described structure according to the present embodiment is described. FIG. 12 is a flowchart of the processing performed by the 3D subtitle process device according to Embodiment 2 of the present invention. More specifically, FIG. 12 illustrates details of internal processing of the 3D subtitle process unit 205.

The processing illustrated in FIG. 12 starts at a time of updating a subtitle. The timing of updating a subtitle is basically a time when a new subtitle data is inputted from the subtitle decoder, or a time of deleting a subtitle from the screen. Of course, the time of updating a subtitle is not specifically limited and may be any desired timing.

First, the 3D subtitle process unit 205 obtains input subtitle data from the subtitle decoder 204, subtitle display setting from the subtitle display setting control unit 208, and display device information from the display device information control unit 209 (S201).

If the input subtitle data is newly obtained, the subtitle region calculation unit 211 calculates a display region on the screen for a subtitle to be newly displayed which is indicated in the input subtitle data, according to the input subtitle data and the subtitle display setting (S202). Then, the subtitle region calculation unit 211 stores, in the subtitle data storage unit 213, a piece of subtitle data including information indicating the calculated display region.

The depth correction unit 212 obtains such pieces of subtitle data of subtitles to be displayed, from the pieces of subtitle data held in the subtitle data storage unit 213 (S203).

The depth correction unit 212 determines whether or not display regions indicated in the obtained pieces of subtitle data overlap each other on the screen (S204). Here, if the display regions do not overlap on the screen (No at S204), then Step S205 is skipped.

On the other hand, if the display regions overlap each other on the screen (Yes at S204), then the depth correction unit 212 corrects at least one disparity indicated in the obtained pieces of subtitle data so that a subtitle having an older display start time has a smaller disparity (S205). Then, the depth correction unit 212 updates the pieces of subtitle data held in the subtitle data storage unit 213 by using the amended disparity.

For example, when there are three target subtitles to be displayed, the processing from Steps S203 to S205 is as follows. First, the depth correction unit 212 obtains pieces of subtitle data of the three target subtitles from the subtitle data storage unit 213. Here, it is possible to determine a target subtitle to be displayed, by determining, for example, whether or not a duration from a display start time of the subtitle to a current time is shorter than or equal to a subtitle display duration indicated in the input subtitle data.

Subsequently, the depth correction unit 212 determines whether or not at least parts of the display regions indicated in the obtained three pieces of subtitle data overlap each other on the screen. Here, if the display regions overlap, the depth correction unit 212 corrects disparities indicated in the obtained three pieces of subtitle data.

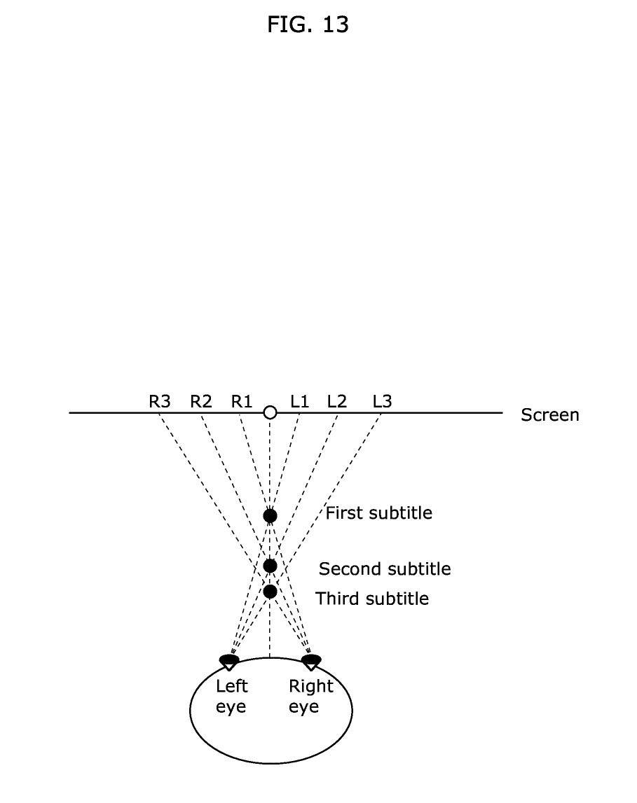

The following describes a method of calculating disparities of the three subtitles with reference to FIG. 13. First, it is assumed that a disparity of a subtitle having the oldest display start time (first subtitle in FIG. 13) is (R1, L1). Here, the depth correction unit 212 calculates a disparity (R3, L3) of the newest subtitle (third subtitle in FIG. 13) by using a fixed offset amount or the like that is previously stored. In addition, the depth correction unit 212 calculates, by using (R1, L1) and (R3, L3), a disparity (R2, L2) of a subtitle (second subtitle in FIG. 13) having a display start time between the oldest display start time and the newest display start time. The depth correction unit 212 may calculate (R2, L2) according to, for example, simple proportionality calculation.

It should be noted that, if the number of target subtitles to be displayed on the screen at the same time is decreased when a disparity is corrected according to the above-described disparity calculation method, a disparity of a target subtitle is enlarged (the target subtitle is displayed to appear nearer to the user than before). However, in the above situation, the depth correction unit 212 may calculate a current disparity not to be larger than the previously-calculated disparity.

The description is back to the flowchart of FIG. 12. The 3D subtitle generation unit 214 and the subtitle drawing unit 215 obtain pieces of subtitle data of the target subtitles in an order of older display start times from the subtitle data storage unit 213, and sequentially draws the subtitles in the order on the OSD memory for drawing the subtitles (S206). By drawing all of the target subtitles, a 3D subtitle image is generated.

As described above, the 3D subtitle process device 200 according to the present embodiment corrects a disparity of at least one of a plurality of subtitles so as to three-dimensionally display the subtitles without causing the user to feel strangeness even if the subtitles overlap on the screen.

As described above, the 3D subtitle process device 200 according to the present embodiment is capable of correcting depth information only when a plurality of subtitles overlap each other on the screen. In other words, the 3D subtitle process device 200 is capable of efficiently correcting depth information only when there is a high possibility that there is a mismatch between a way of overlapping subtitles on the screen and depths of the subtitles. In addition, the 3D subtitle process device 200 can prevent that the correction of depth information deteriorates a depth indicated in the original subtitle data.

### Embodiment 3

The following describes a 3D subtitle process device according to Embodiment 3, by mainly explaining differences from the 3D subtitle process device according to Embodiment 2. It should be noted that a block diagram illustrating a functional structure of the 3D subtitle process device according to Embodiment 3 are the same as the block diagrams according to Embodiment 2 illustrated in FIGS. 5 and 6, so that the block diagram of the 3D subtitle process device according to Embodiment 3 is not provided.

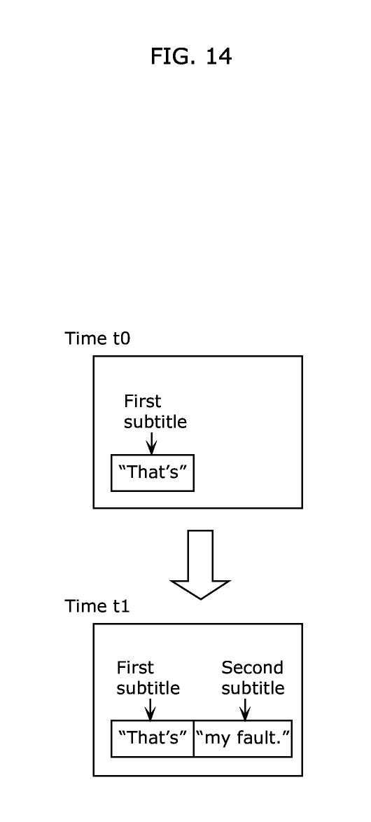

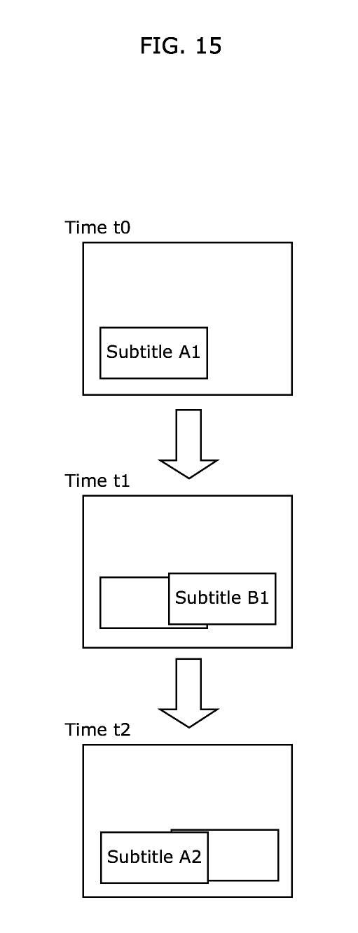

The 3D subtitle process device according to Embodiment 3 determines whether or not to correct depth information to display the newest subtitle to appear the nearest to the user, based on a type and a display start time of the subtitle. The 3D subtitle process device thereby changes depths of subtitles having the same type in a short time, thereby decreasing user's discomfort. Referring to FIGS. 14 and 15, the situation causes the user to feel discomfort is described.

Each of FIGS. 14 and 15 is a diagram for explaining an example of processing performed by a depth correction unit according to Embodiment 3 of the present invention.

In FIG. 14, it is assumed that one person speaks in a scene. It should be noted that, hereinafter, letters between double quotation marks “and” indicate letters displayed on the screen. When “That's” is displayed as the first subtitle at time t0, “my fault.” is displayed as the second subtitle at time t1. In this case, if the first subtitle and the second subtitle have different disparities, a difference of a depth occurs between the two subtitles spoken by the same person at the almost same time. As a result, the difference of the depth causes the user to feel discomfort.

In FIG. 15, it is assumed that a plurality of people make a conversation in a scene. A subtitle A1 corresponding to a speech of a person A is displayed from time t0, a subtitle B1 corresponding to a speech of a person B is displayed from time t1, and subtitle A2 corresponding to another speech of the person A is displayed from time t2. If a plurality of subtitles are displayed in a short time as above, a depth of a subtitle is sequentially switched in a short time which causes user's discomfort.

Therefore, the depth correction unit 212 according to the present embodiment determines whether or not to correct depth information, depending on whether or not types of a plurality of subtitles are the same. More specifically, the depth correction unit 212 corrects at least one of pieces of depth information when a plurality of subtitles have different types, and does not correct any one of the pieces of depth information when a plurality of subtitles have the same type.

Here, a type of a subtitle is information depending on features of a subtitle. For example, a type of a subtitle is a color of the subtitle. For another example, a type of a subtitle may be determined based on type information. The type information may be, for example, previously included in subtitle data associated with a speaker.

Furthermore, the depth correction unit 212 determines whether or not to correct depth information, according to a difference of a display start time between a plurality of subtitles. More specifically, the depth correction unit 212 corrects at least one of pieces of depth information when a difference of a display start time between a plurality of subtitles is greater than or equal to a threshold value, and does not correct any one of the pieces of depth information when the difference is smaller than the threshold value. The threshold value may be set to, for example, a boundary value of a time difference that causes the user to feel discomfort. The boundary value is obtained by experiments or the like.

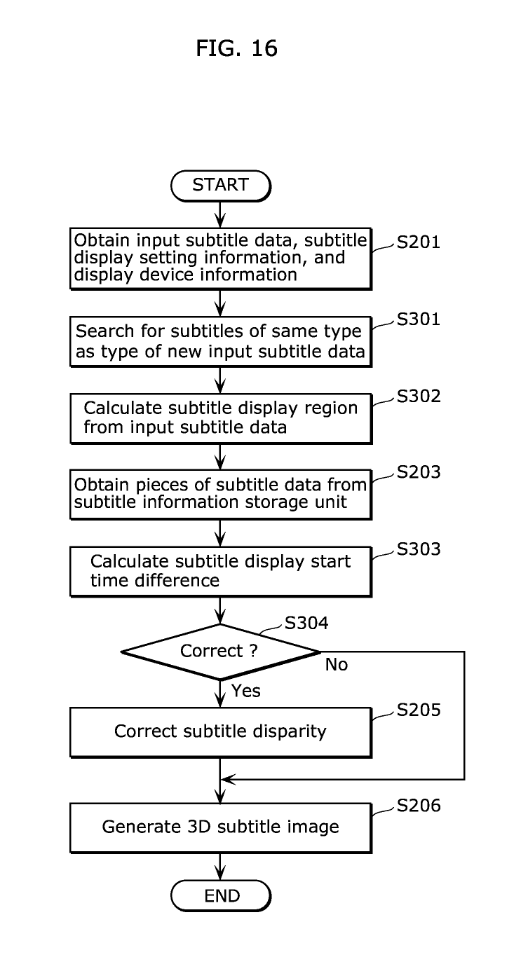

The following describes processing performed by the 3D subtitle process device 200 according to the present embodiment with reference to FIG. 16.

FIG. 16 is a flowchart of the processing performed by the 3D subtitle process device 200 according to Embodiment 3 of the present invention. It should be noted that the same step numbers in FIG. 12 are assigned to identical steps in FIG. 16 and the explanation of the identical steps are appropriately skipped.

After Step S201, the depth correction unit 212 searches for one or more pieces of subtitle data of subtitle(s) having the same type as a type of subtitle data of a subtitle to be newly displayed (hereinafter, the “newest subtitle”) (S301). The type (subtitle type) is, for example, a color of a subtitle. If subtitles spoken by the same person are display in the same color, the user can recognize who speaks each of the subtitles. In this case, a subtitle color can be treated as a subtitle type.

Of course, a subtitle type is not limited to a subtitle color. A subtitle type may be determined based on, for example, a flag or a sequence number included in subtitle data.

Next, like Step S202 in FIG. 12, the subtitle region calculation unit 211 calculates a display region on the screen for a subtitle to be newly displayed (hereafter, the “newest subtitle”) which is indicated in the input subtitle data, according to the input subtitle data and the subtitle display setting (S302). At this step, the subtitle region calculation unit 211 calculates the above display region based on display start times of the searched-out subtitles having the same type. For example, the subtitle region calculation unit 211 calculates the subtitle region of the newest subtitle not to overlap display regions of the searched-out subtitles having the same type, if (a) any of the display regions of the searched-out subtitles is spatially close to (b) the display region of the newest subtitle indicated in the input subtitle data.

Subsequently, after performing Step S203, the depth correction unit 212 calculates a difference between display start times indicated in the pieces of subtitle data (S303) The pieces of subtitle data are obtained at Step S203.

Then, the depth correction unit 212 determines whether or not to correct a disparity (S304). More specifically, if the calculated difference between the display start times is smaller than a threshold value and subtitles of the obtained pieces of subtitle data have the same type, the depth correction unit 212 determines not to correct a disparity of any of the subtitles. On the other hand, if the calculated difference between the display start times is greater than or equal to the threshold value or if the subtitles of the obtained pieces of subtitle data have different types, the depth correction unit 212 determines to correct a disparity of any of the subtitles.

Here, if it is determined to correct a disparity (Yes at S304), then Step S205 is performed. On the other hand, if it is determined not to correct a disparity (No at S304), then Step S205 is skipped.

As described above, the 3D subtitle process device according to the present embodiment is capable of preventing correction of depth information when a plurality of subtitles have the same type. As a result, for example, it is possible to prevent that a plurality of subtitles corresponding to a series of speeches of the same person are three-dimensionally displayed with different depths. Therefore, it is possible to decrease user's discomfort caused by correction of depth information.

In addition, the 3D subtitle process device according to the present embodiment is capable of setting the same depth for a plurality of subtitles when displaying of the subtitles starts sequentially one by one. As a result, for example, it is possible to prevent that a plurality of subtitles corresponding to a series of speeches of the same person are three-dimensionally displayed with different depths. Therefore, it is possible to decrease user's discomfort caused by correction of depth information.

### Embodiment 4

A 3D subtitle process device according to Embodiment 4 of the present invention changes a reproduction mode according to a user's operation for three-dimensionally displayed subtitles.

For example, in the situation where speeches in a non-native language of the user are reproduced and subtitles of the speeches are displayed in a user's native language, the user often watches the subtitles not video. In such a situation, if, in particular, a subtitle is updated at a high speed, a subtitle disappears from the screen before the user has read all of the subtitle. In such a case, the user desires to rewind the video back to the subtitle which the user missed.

Therefore, the 3D subtitle process device 300 according to the present embodiment performs special reproduction (fast-forward, rewind) according to an operation for a displayed subtitle. The following describes the 3D subtitle process device 300 according to the present embodiment with reference to the drawings. It should be noted that, hereinafter, the description is given for the situation where a user's operation is a touch operation on the screen.

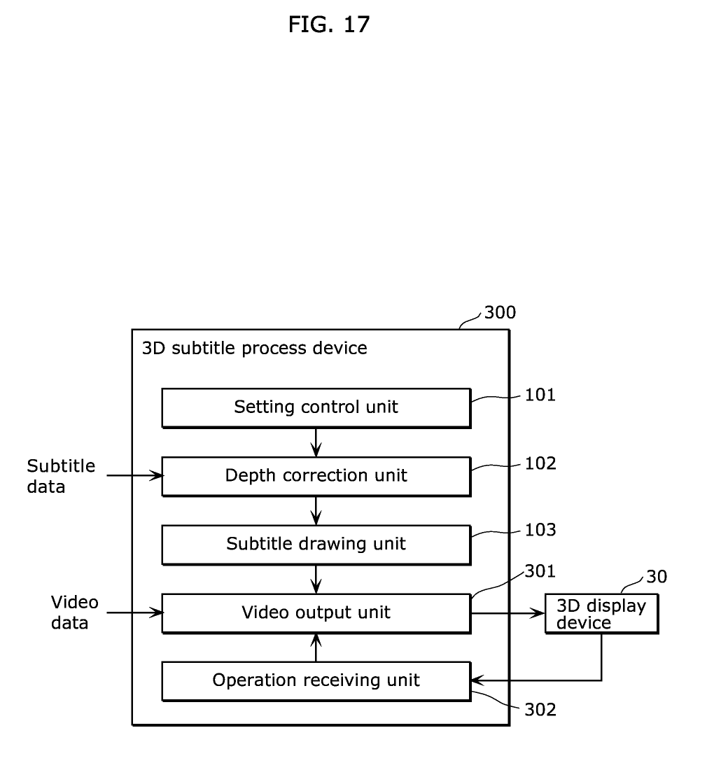

FIG. 17 is a block diagram illustrating a functional structure of the 3D subtitle process device 300 according to Embodiment 4 of the present invention. It should be noted that the same reference numerals in FIG. 2 are assigned to identical structural elements in FIG. 17 and the explanation of the identical structural elements are appropriately skipped.

The 3D subtitle process device 300 is connected to the 3D display device 30. As illustrated in FIG. 17, the 3D subtitle process device 300 includes a setting control unit 101, a depth correction unit 102, a subtitle drawing unit 103, a video output unit 301, and an operation receiving unit 302.

The video output unit 301 outputs a 3D subtitle video in which a 3D video indicated by video data is superimposed with a 3D subtitle image. Here, when a touch operation received by the operation receiving unit 302 is a predetermined touch operation, the video output unit 301 outputs a 3D subtitle video in a special reproduction mode. The special reproduction mode is a so-called trick by which a video is reproduced at a reproduction speed different from a normal reproduction speed.

The operation receiving unit 302 receives a user's touch operation for at least one of a plurality of subtitles three-dimensionally displayed on the 3D display device 30. The touch operation is an operation performed by the user by touching the screen, using a hand, a pen, or the like. The touch operation includes a tap operation, a flick operation, a pinch-out operation, a pinch-in operation, ad drag-and-drop operation, and the like.

Next, the processing performed by the 3D subtitle process device 300 having the above-described structure is described.

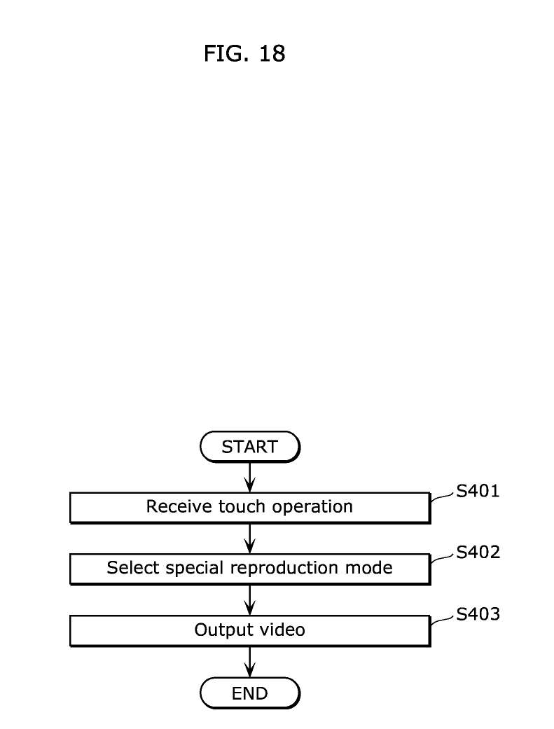

FIG. 18 is a flowchart of the processing performed by the 3D subtitle process device 300 according to Embodiment 4 of the present invention. More specifically, FIG. 18 illustrates the processing performed when a user's touch operation is received.

First, the operation receiving unit 302 receives a user's touch operation (S401). Subsequently, when the received touch operation is a predetermined touch operation, the video output unit 301 selects, from among a plurality of predetermined special reproduction modes, a special reproduction mode associated with the touch operation (S402). The predetermined special reproduction modes include, for example, a fast-forward reproduction mode, a rewind reproduction mode, and the like.

More specifically, when, for example, the received touch operation is a touch operation for moving at least one of the three-dimensionally displayed subtitles to appear near to the user, the video output unit 301 selects the rewind reproduction mode from the special reproduction modes.

Moreover, for example, when the received touch operation is a touch operation for moving at least one of the three-dimensionally displayed subtitles to appear at depth, the video output unit 301 selects the fast-forward reproduction mode from the special reproduction modes. It is also possible that, when receiving a touch operation for moving a plurality of three-dimensionally displayed subtitles to appear at depth, the setting control unit 101 changes subtitle display setting to set a display duration of each of the subtitles for a video on the 3D display device 30 to be greater than a display duration indicated in corresponding subtitle data for the video. It is thereby possible to prevent that a display duration of each of the subtitles is too short in the fast-forward reproduction mode.

Finally, the video output unit 301 outputs a 3D subtitle video in the selected special reproduction mode (S403).

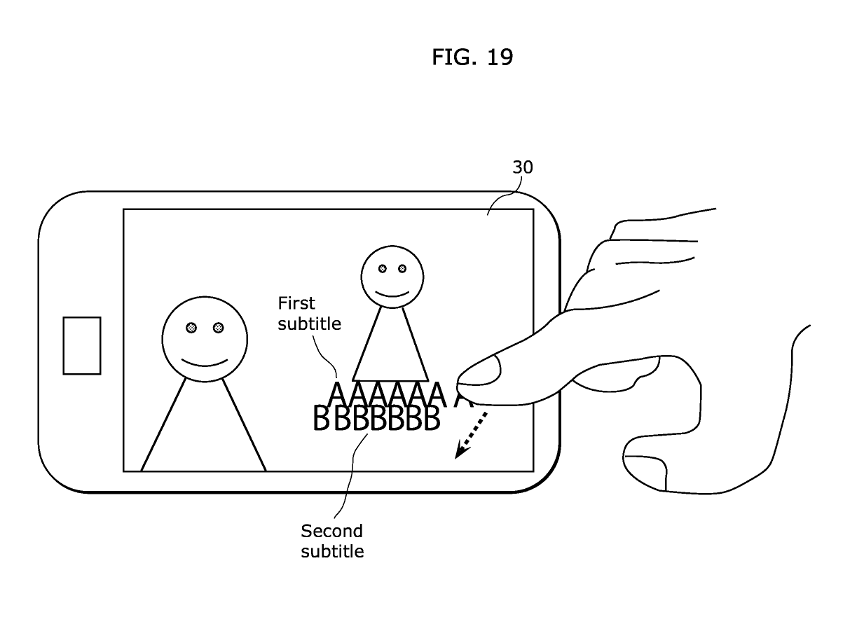

An example of the above-described processing performed by the 3D subtitle process device 300 is described in detail with reference to FIG. 19. FIG. 19 is a diagram for explaining an example of the processing performed by the 3D subtitle process device 300 according to Embodiment 4 of the present invention.

FIG. 19 illustrates the situation where the user watches a 3D subtitle video by a mobile device as the 3D display device 30. In FIG. 19, the first subtitle “AAAAAAA” is three-dimensionally displayed to appear deeper than the second subtitle “BBBBBBB”.

In the situation where the subtitles are three-dimensionally displayed as above, the user taps one of the displayed subtitles by a finger or the like when the user desires special reproduction. When the finger touches the subtitle, the 3D subtitle process device 300 is changed to a “subtitle base mode”. If, in the subtitle base mode, the user performs a flick operation on a currently-displayed subtitle, a past or future subtitle prior or subsequent to the currently-displayed subtitle is displayed and the video is rewound or fast forwards to a scene corresponding to the past or future subtitle.

For example, as indicated by an arrow in FIG. 19, if the user performs an touch operation to move the first subtitle to be closer to the second subtitle that is three-dimensionally displayed ahead of the first subtitle, the 3D subtitle video is rewound to a time of starting the display of the first subtitle.

As described above, the 3D subtitle process device 300 according to the present embodiment is capable of outputting a 3D subtitle video in a special reproduction mode associated with a user's touch operation for a three-dimensionally displayed subtitle. In other words, the user can control the special reproduction mode by an intuitive operation on a subtitle.

In addition, the 3D subtitle process device 300 according to the present embodiment is capable of performing rewind reproduction by a touch operation for moving a three-dimensionally displayed subtitle to appear near to the user. In other words, since the 3D subtitle process device 300 can realize rewind reproduction by an operation for approaching an old subtitle to a new subtitle, the user can control a special reproduction mode by an intuitive operation on a subtitle.

Furthermore, the 3D subtitle process device 300 according to the present embodiment is capable of performing fast-forward reproduction by a touch operation for moving a three-dimensionally displayed subtitle to appear at depth. In other words, since the 3D subtitle process device 300 can realize fast-forward reproduction by an operation for approaching a new subtitle to an old subtitle, the user can control a special reproduction mode by an intuitive operation on a subtitle.

It should be noted that it has been described in Embodiment 4 like in Embodiments 1 to 3 that subtitles are three-dimensionally displayed, but it is not necessarily to three-dimensionally display subtitles. It is also possible that subtitles and a video are two-dimensionally displayed as usual. Even if subtitles are two-dimensionally displayed as above, a subtitle video is outputted in a special reproduction mode according to a user's touch operation for a target displayed subtitle, so that the user can intuitively display a desired subtitle.

It should also be noted that the processing performed by the 3D subtitle process device 300 in response to an touch operation is an example, and any other processing may be performed. For example, it is possible to change a size of a subtitle, when the user performs a pinch-out or pinch-in operation in the “subtitle base mode”. In other words, the setting control unit 101 may change subtitle display setting regarding a subtitle display size according to a user's touch operation for a subtitle three-dimensionally displayed on the 3D display device 30. It is also possible to change a position of a displayed subtitle when the user drags and drops the subtitle.

The user's operation may be performed not only for a mobile device but also for a pointer device for a large screen of a television set or the like.

Although the 3D subtitle process devices according to the aspects of the present invention have been described with reference to a plurality of embodiments as above, the present invention is not limited to these embodiments. Those skilled in the art will be readily appreciated that various modifications of the exemplary embodiments and combinations of the structural elements of the different embodiments are possible without materially departing from the novel teachings and advantages of the present invention. Accordingly, all such modifications and combinations are intended to be included within the scope of the present invention.

For example, although it has been described in each of Embodiments 1 to 4 that the depth correction unit corrects depth information based on the subtitle data, it is also possible to correct depth information based on other information. For example, depth information may be corrected based on video data or audio data. More specifically, for example, in calculation of a disparity of a subtitle, the depth correction unit may calculate the disparity so that the disparity is greater in proportion to a sound volume obtained from audio data, or calculate a disparity of a subtitle based on a disparity of a video obtained from video data.

Furthermore, although it has been described in each of Embodiments 1 to 4 that the 3D subtitle process device and the 3D display device are different devices, it is also possible, for example, that the 3D subtitle process device is embedded in the 3D display device. In other words, the 3D display device may include the 3D subtitle process device.

It should be also noted that a part or all of the structural elements included in each of the 3D subtitle process devices according to Embodiments 1 to 4 may be implemented into a single Large Scale Integration (LSI). For example, the 3D subtitle process device may be a system LSI including the setting control unit 101, the depth correction unit 102, and the subtitle drawing unit 103 which are illustrated in FIG. 2.

The system LSI is a super multi-function LSI that is a single chip into which a plurality of structural elements are integrated. More specifically, the system LSI is a computer system including a microprocessor, a Read Only Memory (ROM), a Random Access Memory (RAM), and the like. The RAM holds a computer program. The microprocessor operates according to the computer program to cause the system LSI to perform its functions.

Here, the integrated circuit is referred to as a LSI, but the integrated circuit can be called an IC, a system LSI, a super LSI or an ultra LSI depending on their degrees of integration. The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

Furthermore, the present invention can be implemented not only into the 3D subtitle process device including the above-described characteristic structural elements, but also into a 3D subtitle process method including steps performed by the characteristic structural elements included in the 3D subtitle process device. In addition, the present invention can be implemented into a computer program for causing a computer to perform the characteristic steps included in the 3D subtitle process method. Moreover, of course, the computer program can be distributed via a non-transitory computer-readable recording medium such as a Compact Disc-Read Only Memory (CD-ROM) or via a communication network such as the Internet.

### INDUSTRIAL APPLICABILITY

The preset invention can be used as a 3D subtitle process device which enables a user to watch 3D subtitles without feeling any strangeness even if a 3D display device changes a method of displaying the subtitles.

### REFERENCE SIGNS LIST

10, 30 3D display device
100, 200, 300 3D subtitle process device
101 setting control unit
102, 212 depth correction unit
103, 215 subtitle drawing unit
201 demultiplexer
202 audio decoder
203 video decoder
204 subtitle decoder
205 3D subtitle process unit
206 audio output unit
207, 301 video output unit
208 subtitle display setting control unit
209 display device information control unit
211 subtitle region calculation unit
213 subtitle data storage unit
214 3D subtitle generation unit
302 operation receiving unit

1. A three-dimensional (3D) subtitle process device that causes a 3D display device to three-dimensionally display a plurality of subtitles indicated in pieces of subtitle data, the 3D subtitle process device comprising:
a setting control unit configured to control subtitle display setting regarding a subtitle display method performed by the 3D display device;
a depth correction unit configured to, when the subtitle display setting instructs a change of the subtitle display method and a plurality of subtitles each indicated in a corresponding one of pieces of subtitle data are to be displayed temporally overlapping on a screen, correct at least one of pieces of depth information each included in a corresponding one of the pieces of the subtitle data, so that a subtitle that starts display earlier among the subtitles is three-dimensionally displayed to appear deeper; and
a subtitle drawing unit configured to generate a 3D subtitle image from the pieces of the subtitle data in which the at least one of the pieces of the depth information has been corrected, so as to cause the 3D display device to three-dimensionally display the subtitles.

2. The 3D subtitle process device according to claim 1 further comprising
a subtitle region calculation unit configured to calculate, based on the pieces of the subtitle data and the subtitle display setting, display regions of the subtitles on the screen,
wherein the depth correction unit is configured to correct the at least one of the pieces of the depth information when at least parts of the display regions which are calculated overlap each other on the screen.

3. The 3D subtitle process device according to claim 1,
wherein the depth correction unit is configured (i) to correct the at least one of the pieces of the depth information when the subtitles have different types, and (ii) not to correct the pieces of the depth information when the subtitles have a same type.

4. The 3D subtitle process device according to claim 1,
wherein the depth correction unit is configured (i) to correct the at least one of the pieces of the depth information when a difference of a display start time between the subtitles is greater than or equal to a threshold value, and (ii) not to correct the pieces of the depth information when the difference is smaller than the threshold value.

5. The 3D subtitle process device according to claim 1,
wherein the setting control unit is configured to control, as the subtitle display setting, setting regarding at least one of a subtitle display size and a subtitle display duration in the 3D display device.

6. The 3D subtitle process device according to claim 1 further comprising:
a video output unit configured to output, to the 3D display device, a 3D subtitle video in which the 3D subtitle image is superimposed on a 3D video; and
an operation receiving unit configured to receive an operation of a user for at least one of the subtitles three-dimensionally displayed on the 3D display device,
wherein the video output unit is configured to output the 3D subtitle video in a special reproduction mode, when the operation received is a predetermined operation.

7. The 3D subtitle process device according to claim 6,
wherein, when the operation received is an operation for moving at least one of the subtitles that are three-dimensionally displayed to appear near to the user, the video output unit is configured to output the 3D subtitle video in a rewind reproduction mode.

8. The 3D subtitle process device according to claim 6,
wherein, when the operation received is an operation for moving at least one of the subtitles that are three-dimensionally displayed to appear at depth, the video output unit is configured to output the 3D subtitle video in a fast-forward reproduction mode.

9. The 3D subtitle process device according to claim 8,
wherein, when an operation for moving at least one of the subtitles that are three-dimensionally displayed to appear at depth is received, the setting control unit is configured to change the subtitle display setting so that a display duration of each of the subtitles for a video on the 3D display device is longer than a display duration of a subtitle for the video which is indicated in a corresponding one of the pieces of the subtitle data.

10. A three-dimensional (3D) subtitle process method of causing a 3D display device to three-dimensionally display a plurality of subtitles indicated in pieces of subtitle data, the 3D subtitle process method comprising:
controlling subtitle display setting regarding a subtitle display method performed by the 3D display device;
correcting at least one of pieces of depth information each included in a corresponding one of the pieces of the subtitle data, so that a subtitle that starts display earlier among the subtitles is three-dimensionally displayed to appear deeper, when the subtitle display setting instructs a change of the subtitle display method and a plurality of subtitles each indicated in a corresponding one of pieces of subtitle data are to be displayed temporally overlapping on a screen; and
generating a 3D subtitle image from the pieces of the subtitle data in which the at least one of the pieces of the depth information has been corrected, so as to cause the 3D display device to three-dimensionally display the subtitles.
